(19) United States
(12) Patent Application Publication
(10) Pub. No.: US 2011/0100335 A1
(43) Pub. Date: May 5, 2011

(54) FUEL DELIVERY SYSTEM

(75) Inventors: William R. Parlatore, Annapolis, MD (US); Howard A. Brooks, Annapolis, MD (US)

(73) Assignee: Marine Green, LLC

(21) Appl. No.: 12/612,776

(22) Filed: Nov. 5, 2009

(51) Int. Cl. F02M 37/00; F02B 43/00

(52) U.S. Cl. 123/511; 123/527

(57) ABSTRACT

A method and system for fuel delivery. The method and system may include one or more fuel storage tanks housing propane, one or more regulators through which fuel may flow and one or more fuel metering devices or systems. The flow of fuel from a fuel storage tank to an engine may be such that the engine runs in a clean and efficient manner.

### BACKGROUND

Engines used in any application are known to utilize fuel. In many applications, such as in two and four stroke marine outboard engines, fossil fuels been used as the primary source of fuel. However modern engines are typically criticized for their use of fossil fuels as they are claimed to not be environmentally friendly. Two stroke engines are further criticized due to their running and use characteristics. Thus, in many applications where two stroke engines used to be prevalent, such as in marine outboard engines, designers and manufacturers are now switching to four stroke outboard engines.

However, as is well known and publicized, four stroke engines remain somewhat inefficient and suffer from a variety of potential drawbacks, specifically with regard to the environment. A number of solutions have been proposed to increase both the efficiency and environmental friendliness of such engines. For example, some marine outboard engines now utilize alternative fuels, such as ethanol-infused gasoline, or bio-gas. These alternatives cause a variety of problems in many applications, however. The use of ethanol in gasoline can absorb water which can cause onboard fuel supplies to eventually contain water as a result of condensation or other means, causing significant problems in engines that are used less frequently. Additionally, for users who wish to safeguard their outboard engines from these problems, fuel disposal is often viewed as a solution but environmentally-unfriendly manners of disposing of unused fuel are often implemented.

Additionally the decreased effective shelf life of alternative fuels, such as bio-gas can pose problems in engines that are used less frequently as the fuel may not properly combust if it is not used within a limited time period.

Other attempted solutions, for example the use of liquid propane delivery systems, have not proved successful. In such uses of propane, the vaporization of propane from its liquid state causes a significant amount of heat to be absorbed, ultimately freezing the regulator through which the propane flows from a tank to the engine and rendering the engine inoperable.

### SUMMARY

One exemplary embodiment describes a fuel delivery system. The fuel delivery system may include a fuel tank that houses propane; a first regulator coupled to the fuel tank; a second regulator coupled to the first regulator; and a fuel metering system coupled to the second regulator and delivering propane to an engine.

Another exemplary embodiment can include a method for providing fuel to an engine. The method for providing fuel to an engine can include storing liquid propane in a tank; flowing the liquid propane to a first regulator; converting the liquid propane to a propane vapor by the first regulator; flowing the propane vapor to a second regulator; metering the flow of the propane vapor from the second regulator to an engine; and maintaining the temperature of the propane at about an ambient temperature.

### BRIEF DESCRIPTION OF THE FIGURES

Advantages of embodiments of the present invention will be apparent from the following detailed description of the exemplary embodiments thereof, which description should be considered in conjunction with the accompanying drawings in which:

FIG. 1 shows an exemplary block diagram of a fuel delivery system.

FIG. 2 shows an exemplary diagram of components of a fuel delivery system and engine.

FIG. 3 shows another exemplary diagram of components of a fuel delivery system and engine.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

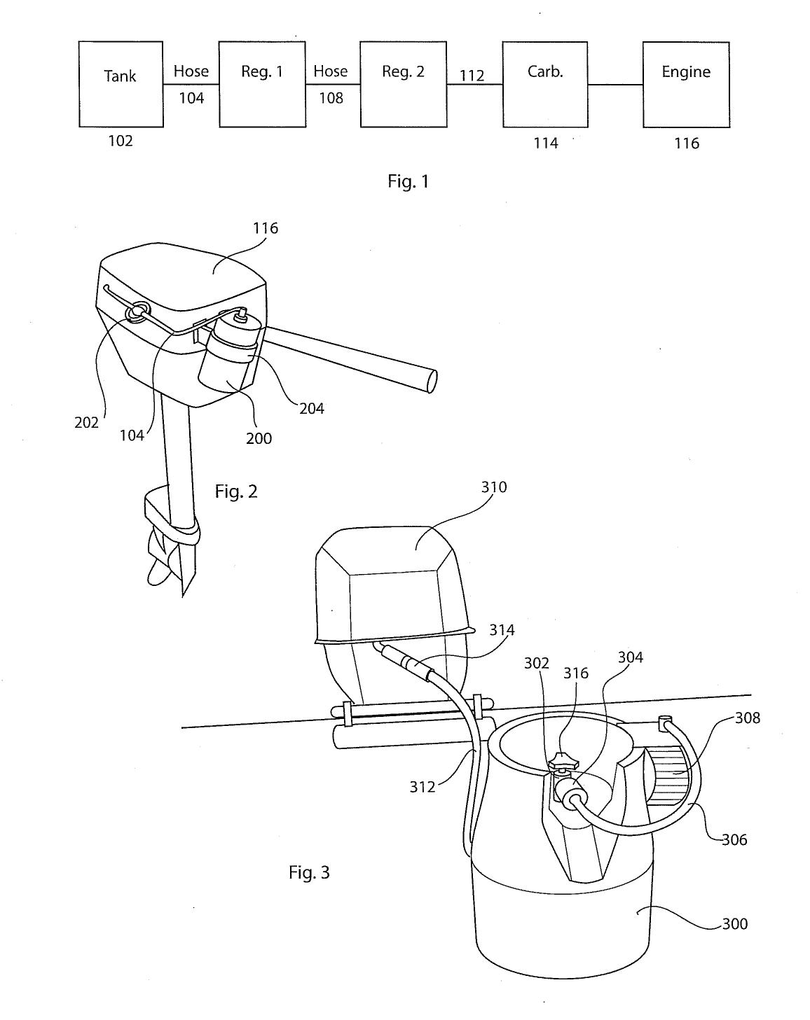

Generally referring to FIGS. 1-3, a propane vapor delivery system may be described and shown. The fuel vapor delivery system may be such that clean, economical use of an engine may be achieved with minimal complexity.

In one exemplary embodiment and as shown in the exemplary diagram in FIG. 1, a gas, such liquefied petroleum gas or propane, may be supplied to an engine as fuel. The gas may be stored in a bottle or tank, such as LPG tank 102. In a further exemplary embodiment, the gaseous form of liquefied propane may be used as a fuel for marine outboard four-stroke propulsion engines, as well as two stroke engines or any other type of engine with a pressurized lubricating injection system. An exemplary fuel system may use liquefied petroleum gas (LPG or propane) which may be stored in a vapor gaseous state in LPG tank 102 and which may not utilize engine coolant to keep regulators from freezing or otherwise malfunctioning.

LPG, as implemented or utilized in the exemplary embodiments described herein, may provide any of a number of advantages over other fuels. For example, LPG may act as a higher octane fuel source as well as decrease potentially harmful emissions while also offering substantially the same or better performance over other known fuels. An increase in fuel economy and a decrease in potentially harmful emissions may be up to 20% or more. Additionally, LPG may reduce wear on an engine and some components, for example extending the life of spark plugs, reducing varnish build-up on a carburetor and increasing the amount of time needed between oil changes. Further, LPG may be stored in any number of environments without the use of additives or unique storage conditions without affecting its usefulness or performance.

In a further exemplary embodiment, the LPG tank 102 may be connected to a regulator, such as a primary regulator 106, converter or vaporizer. This connection may be made using a hose 104, such as a high pressure hose, or any form of pipe, for example a rigid pipe. The primary regulator 106 may step down the pressure of any stored propane vapor energy in tank 102, and may further output this lowered pressure to a secondary regulator 110. For example, the primary regulator 106 may be such that it reduces pressure of the propane from a high pressure state while the propane is in the LPG tank 102, which may be approximately 180-250 psi, to a sub-atmospheric pressure, approximately 10 psi. The secondary regulator 110 can act as a vacuum-controlled flow rate regulator. Further, the secondary regulator 110 can meter propane gas to an engine 116, for example, through a negative pressure signal, such as a vacuum signal, from the air-fuel mixer on a carburetor 114 designed or modified to use propane as a fuel source.

Still to exemplary FIG. 1, and in a further example, the carburetor 114 may include both an air-fuel mixer and a throttle body. When the engine 116 is being cranked or otherwise running, a partial vacuum may be generated in the throttle body of carburetor 114. This partial vacuum may be passed on from the throttle body to the fuel vapor hose to the secondary regulator 110. The secondary regulator 110 may sense the vacuum and open, letting fuel vapor flow into the carburetor 114. As the throttle is opened, a butterfly valve inside the carburetor 114 may open further, thus allowing for more fuel to be drawn in and allowing the engine 116 to accelerate or increase revolutions. Further, the air-valve implementation of the carburetor 114 may allow for a safe and accurate method of supplying propane gas from LPG tank 102 while also allowing for the fuel metering in the mixer to be self-contained. Additionally, it may be envisioned that a mechanical or electrical fuel injection system could be used in lieu of carburetor 114 while achieving similar results.

In further exemplary embodiments, and referring to FIG. 2, the regulator arrangement of the primary regulator 106 and the secondary regulator 110 may be such that they are combined as a single, two-stage, regulator 202. In this exemplary embodiment the combined regulator 202 would then feed the vaporized propane into carburetor 114 through hose 112. Additionally, as shown in exemplary FIG. 2, LPG tank 200, in some examples, may be coupled directly to engine 116, using any desired coupling, such as mounting bracket 204.

The exemplary embodiment shown in FIG. 2 may be utilized in any desired situation, such on a small or single-cylinder outboard engine. The mounting of LPG tank 200 on the engine may provide many advantages. For example, this embodiment may be beneficial in some desired situations, for example when utilizing compact fuel supplies on a general yacht tender service or for any other similar-sized application, such as generators or personal watercraft where storage space or space of a fuel tank may be limited.

In still further exemplary embodiments, and referring to FIG. 3, the LPG tank 300 may be located separate, but coupled to, an engine 310. The LPG tank 300 may be connected to the primary regulator 304 as described previously, for example by connector 302. Additionally, a low pressure output of the secondary regulator 308 may be attached to a propane carburetor (not pictured) on the engine 310 in any of a variety of manners, for example through hose 312 and coupling 314. Further, a low pressure output of the secondary regulator 308 may be attached to the propane carburetor either permanently or releasably.

Still referring to exemplary FIG. 3, the primary regulator 304 and the secondary regulator 308 may be two separate regulators that can be based on the design and size of an engine. The primary regulator 304 in this exemplary embodiment may be connected to LPG tank 300 as described above. Additionally, the primary regulator 304 may be connected to the secondary regulator 308 by a hose 306, pipe, tube or the like, such as that described above.

In each of the exemplary embodiments described herein the arrangement of the regulators 106 and 110, 202 and 304 and 308, as shown in FIGS. 1-3, respectively, can maintain about an ambient temperature from the surrounding air temperature rather than utilizing an interface with a cooling circuit of the engine 116 or other heat source to function as desired. In some other exemplary embodiments, the temperature maintained by any regulators described herein may be such that the flow of propane is allowed as desired. This may be accomplished as a result of the vapor delivery nature of the system as well as a design match of the system to fit specific air-fuel requirements of an engine size, for example for a marine engine. The maintenance of the regulator at about an ambient temperature may be facilitated by both the design of the regulator or regulators which may be sized to a specific engine, for example a marine engine having a known or desired horsepower rating. Additionally, the maintenance of the about ambient temperature may be such that the regulator or regulators are not affected, for example, by freezing as a result of the conversion of the LPG from tank 102 to a gaseous state and the flow of the fuel is not negatively affected or impacted.

In still further examples, any of the embodiments described herein may include a fuel shut-off valve, such as a safety fuel shut-off valve 316 or switch. For example, a standard propane tank shut-off valve may be utilized in some embodiments. Additionally, in other embodiments, such as embodiments where a larger, electrically actuated engine is utilized, an electric solenoid shut-off valve may be used.

In still other exemplary embodiments, for example engines as shown in FIG. 3, which may be large or powerful engines, or any situation where more fuel may be desired, an LPG tank may be mounted or located in any desired position or location. Whereas the LPG tank shown in exemplary FIG. 2 may be mounted on the side of an engine, here other locations for mounting an LPG tank may be used as desired. As shown in FIG. 3, a mounting bracket (not pictured) may be secured to LPG tank 300 and any other desired member of a vessel or craft associated with engine 310. Also the LPG tank 300 may be formed out of any desired material, for example aluminum or a composite construction. Additionally, the LPG tank 300 may be coupled with any conduit described herein, such as a high pressure hoses, rigid tubes, pipes and the like in any desired manner, such as a screw fitting. Additionally, should it be desired, any number of fuel tanks may be coupled together to provide any desired amount of available fuel. Any coupling of additional tanks may be done in a manner known in the art.

Further, as described herein, the LPG applications may be used on any desired form of engine, such as marine outboard engines, and may further operate independently of an engine's cooling circuit. This may be accomplished through the use of vapor fuel delivery rather than the delivery of liquid propane gas. Additionally, on some engine types, such as engines of smaller displacement, smaller amounts of propane may be utilized to achieve a desired operation, thus further issues pertaining to cooling and freezing, such as those known to affect the conversion of propane from liquid to gas, may be avoided.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A fuel delivery system, comprising:
a fuel tank that houses propane;
a first regulator coupled to the fuel tank;
a second regulator coupled to the first regulator; and
a fuel metering system coupled to the second regulator to deliver propane vapor to an engine.

2. The fuel delivery system of claim 1, wherein the engine is a marine outboard engine.

3. The fuel delivery system of claim 1, wherein the fuel is reduced in pressure by the first regulator.

4. The fuel delivery system of claim 1, wherein the second regulator receives a signal from the fuel metering system and delivers fuel to the fuel metering system.

5. The fuel delivery system of claim 4, wherein the signal is a vacuum signal.

6. The fuel delivery system of claim 1, wherein the fuel metering system is a carburetor.

7. The fuel delivery system of claim 1, wherein the fuel is propane.

8. The fuel delivery system of claim 1, wherein the first regulator and the second regulator are combined as a two stage regulator.

9. The fuel delivery system of claim 1, wherein the coupling of the first regulator with the second regulator is such that fuel flowing between the first regulator and the second regulator is kept at an about ambient temperature.

10. The fuel delivery system of claim 1, wherein the second regulator is coupled to the fuel metering system with a releasable coupling.

11. The fuel delivery system of claim 1, further comprising at least one shut-off valve.

12. A method for providing fuel to an engine, comprising:
storing liquid propane in a tank;
flowing propane to a first regulator;
decreasing the pressure of the propane by the first regulator;
flowing the propane to a second regulator;
metering the flow of the propane from the second regulator to an engine; and
maintaining the temperature of the propane at an about ambient temperature.

13. The method of claim 12, wherein the flow of the propane vapor from the second regulator to the engine is metered by a carburetor.

14. The method of claim 12, further comprising reducing the pressure of the liquid propane in the tank from about 180-250 psi to about 4-12 psi by the first regulator.

15. The method of claim 12, further comprising one of releasably coupling the second regulator to the engine and releasably coupling the first regulator to the second regulator.

16. The method of claim 12, wherein the flow of the propane vapor from the second regulator to the engine is metered by a vacuum signal.

17. The method of claim 12, wherein the flow of the propane vapor from the second regulator to the engine is metered by a carburetor.

18. The method of claim 12, wherein the flow of the propane vapor from the second regulator to the engine is metered by a fuel injection system.

19. The method of claim 12, further comprising securing the tank to the engine.

20. The method of claim 12, wherein the engine is a marine outboard engine.
